(19) United States
(12) Patent Application Publication
(10) Pub. No.: US 2012/0024171 A1
(43) Pub. Date: Feb. 2, 2012

(54) KETTLE GRILL ACCESSORY

(76) Inventor: Robert T. Estes, St. Louis, MO (US)

(21) Appl. No.: 13/180,936

(22) Filed: Jul. 12, 2011

Related U.S. Application Data
(60) Provisional application No. 61/364,612, filed on Jul. 15, 2010.

(51) Int. Cl. A23B 4/044

(52) U.S. Cl. 99/482

(57) ABSTRACT

An accessory (10) for converting a grill (G) into a smoker comprises a sheet that sits vertically through a cooking grate (R) portion of the grill and resting on a charcoal grate (P) to divide the grill, when a cover (C) is placed over it into a heat chamber (HC) and a smoke chamber (SC). Wood (W) is smoldered on charcoal (B) in the heat chamber and food to be smoked is placed on a portion of the cooking grate within the smoke chamber. The sheet has holes (20) or vents (24), or a combination of holes and vents to allow passage of heated air from the heat chamber into the smoke chamber to smoke the food.

### CROSS-REFERENCE TO RELATED APPLICATIONS

U.S. provisional application 61/364,612 filed Jul. 15, 2010.

### STATEMENT REGARDING FEDERALLY SPONSORED RESEARCH

Not Applicable.

### BACKGROUND OF THE INVENTION

This invention relates to grills and smokers; and, more particularly, to a kettle grill accessory that allows the grill to be converted to a smoker.

As is known in the art, a kettle grill is generally used for grilling or barbecuing meat, fish, or poultry. Meat, for example, is placed on the top of a grill or cooking grate with heat from lump charcoal or charcoal briquettes being directed at the meat to cook it. Many grills are equipped with a lid or cover that fits over a tub in which the lump charcoal or briquettes are placed, the grilling cooking grate comprising an open frame atop the tub on which the meat, fish, or poultry is placed.

A smoker, on the other hand, is a device that exposes the cooking meat, fish, or poultry to the smoke from a flavored wood or briquettes. Typically, a smoker consists of a firebox, a cooking grate on which the meat is placed, and a lid that traps smoke inside it, so to create a smoke chamber. Unlike grills, smokers are designed for indirect cooking; that is, the meat is off to one side of, or next to, the heat source, not directly over it as with a conventional grill.

Smokers for smoking a reasonable quantity of meat at one time are expensive. But, many people already own a grill. The present invention is an accessory for a kettle grill that allows the user to readily convert their grill to a smoker.

### BRIEF SUMMARY OF THE INVENTION

The present invention is directed to an accessory for a kettle grill for converting the grill to a smoker. The accessory comprises a one or two-piece, stamped or cut metal plate sized to be conveniently set in the grill. If a two-piece accessory, the plate sections are welded or hinged together. The plate includes a slot that allows the user to mount the accessory on the grill so it sets vertically when in place. The accessory, when installed, defines a heat chamber on one side of the accessory and a smoke chamber on the other side of it. Charcoal or the like are placed in the tub on the heat chamber side of the accessory so to create heat when ignited and burning. Wood is then placed on the heat source to smolder, thus creating smoke. The meat, fish, or poultry are placed on the grill cooking grate on the smoke chamber side of the accessory. When the meat is on the grill cooking grate and the charcoal or briquettes are ignited, the kettle's lid is placed over the top of the tub to enclose the smoking chamber.

The accessory has a plurality of heat baffles and holes cut into it, so to allow smoke from the heating chamber into the smoking chamber. The heat and smoke then cook the food by indirect rather than direct heating. When the smoking is completed, the lid is removed exposing the smoked meat, fish, or poultry.

After the smoked food is removed from the grill, the accessory is simply lifted of the grill that can now be used for grilling or barbecuing.

The accessory is lightweight so to be readily installed and removed. The accessory is readily cleaned for subsequent uses. The accessory is also easily stored beneath the grill or with implements used for grilling.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings that form a part of the specification.

FIG. 1 is a plan view of a barbecue grill with the accessory of the present invention installed;

FIG. 2 a sectioned elevation view of the grill with the accessory installed; and,

FIG. 3A is a plan view of a first embodiment of the accessory and FIG. 3B is an elevation view thereof.

FIG. 4 is a perspective view of the accessory.

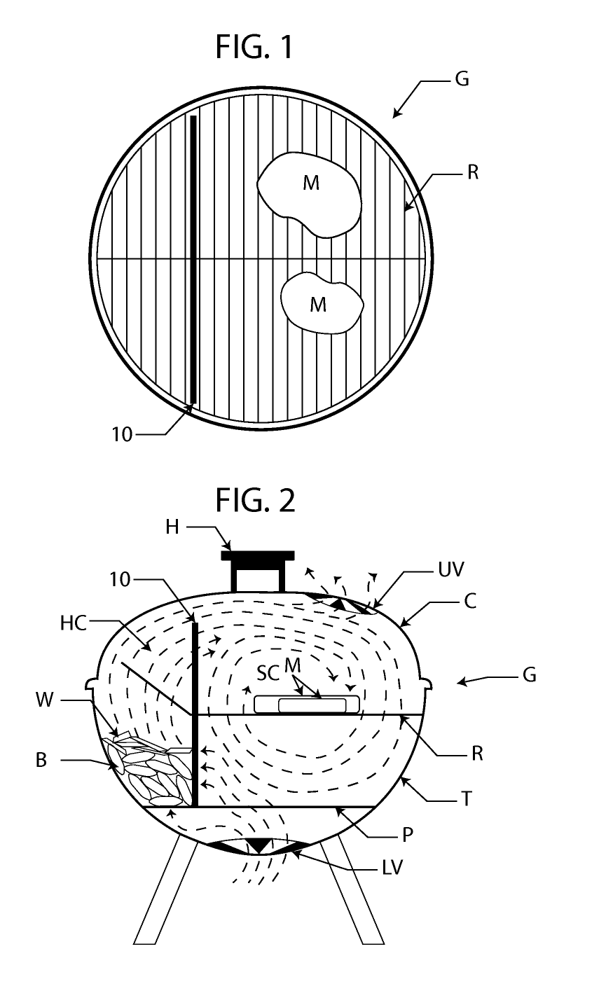

Corresponding reference characters indicate corresponding parts throughout the several views of the drawings.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

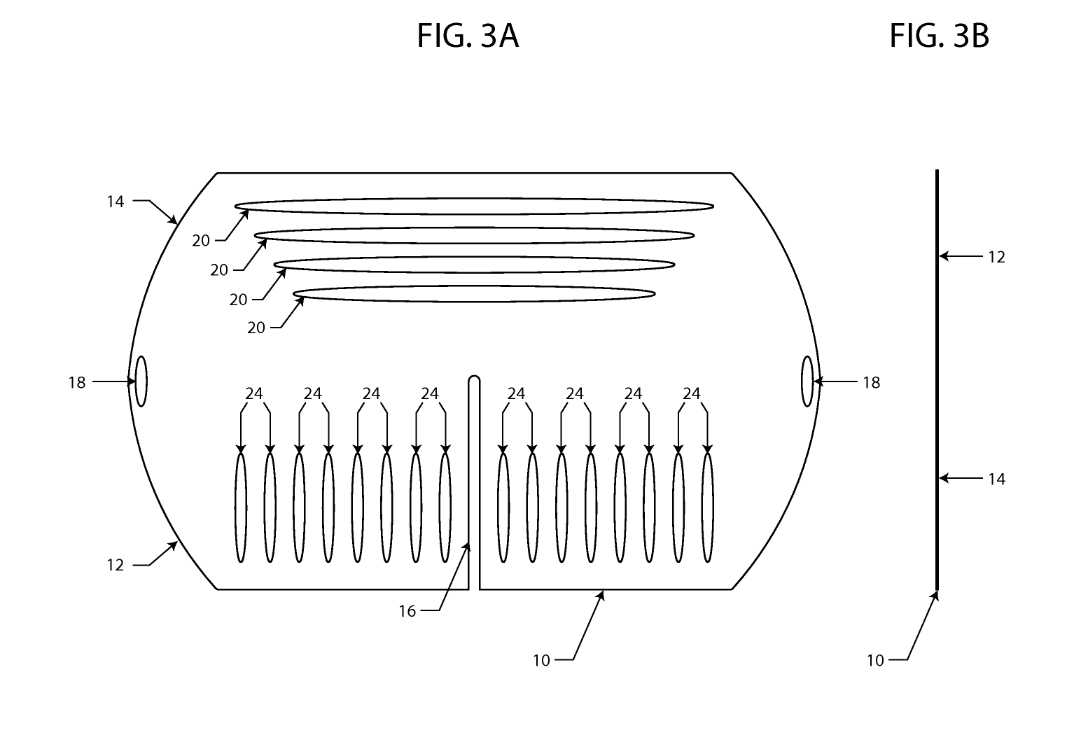

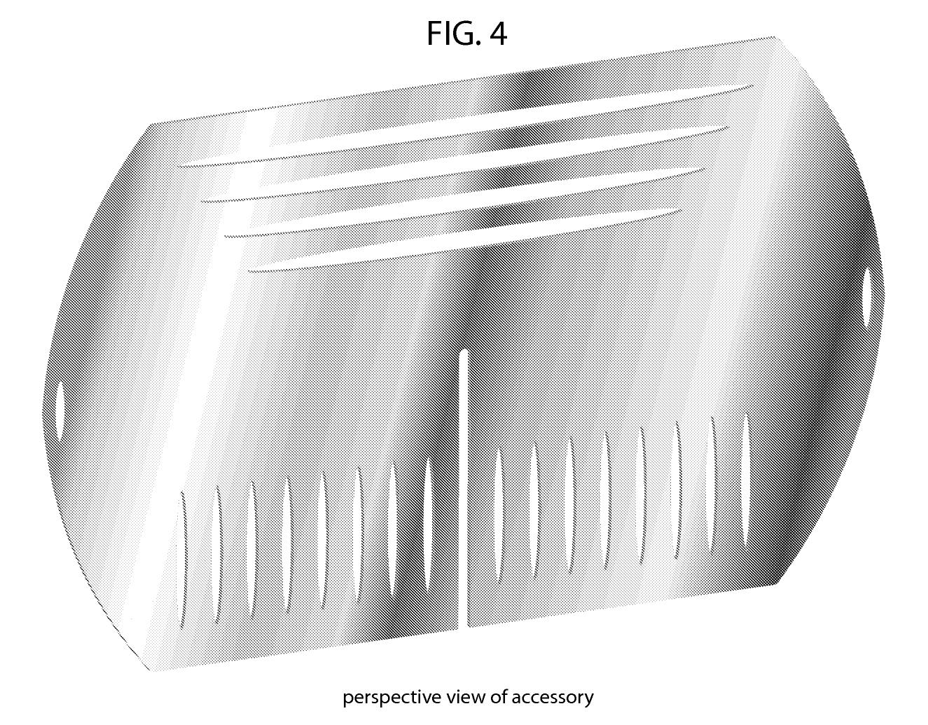

Referring to the drawings, a grill G includes a tub or base T in the bottom of which is a charcoal grate P on which wood W and charcoal generally indicated B in FIG. 2 are placed. A hinged cooking grate R is set across the upper, open end of the tub and meat M, fish, poultry, and vegetables to be grilled are placed on top of the cooking grate. If desired, a cover C is set over the top of the grill to enclose the heat. The cover includes a handle H for lifting and moving the cover. As shown in FIG. 2, air is drawn into tub T through a lower adjustable air vent LV and the smoke and heated air exit the closed grill through the upper vent UV located in the cover C. The amount of air drawn into the kettle by adjusting the size of vent LV and the amount of air allowed to exit through an upper vent UV controls the temperature.

In accordance with the present invention, an accessory indicated generally 10 comprises a plate installed on cooking grate R of the grill to convert the grill into a smoker. As shown in FIG. 2, the accessory sits vertically on the cooking grate and has a lower section 12 that extends beneath the cooking grate, and an upper section 14 that extends above the cooking grate. When in place, accessory 10 divides the grill into a heating chamber HC and a smoker chamber SC. That is, the charcoal B and wood W are placed in the bottom of the tub on the heat chamber side of the accessory, and when burning, the heat and smoke they give off are directed to the smoker chamber side of the grill. The food to be smoked is placed on the cooking grate on the smoke chamber side of the grill. Again as shown in FIG. 2, when food is to be smoked, cover C is placed over the tub to retain the heat and smoke.

Referring to FIGS. 3A and 3B, accessory 10 is shown as being made from a single sheet of metal. However, those skilled in the art will appreciate that the accessory can be made from two separate sheets that are welded or hinged together. As shown in FIG. 3A, the accessory is generally straight across the top and bottom but has rounded sides which bow slightly outwardly. A vertically extending slot 16 extends from the bottom of the sheet approximately halfway up the height of the sheet. The width of the slot is sufficient to allow the accessory to be set in place through cooking grate R with half the accessory extending below the cooking grate, resting the lower portion 12 on the charcoal grate P and the other half of the accessory rising above the cooking grate R.

As shown in FIG. 3A, a plurality of vent holes are made in the sheet of metal, the holes being made in both upper and lower sections 12 and 14 of the accessory. Four horizontally formed holes 20 extend across the upper section 14. One row of sixteen identically formed holes 24 are formed in the bottom section of the accessory 12. The number of vent holes 20 and 24 and their arrangement is designed to allow fresh air to flow to the charcoal B and to allow smoke to efficiently flow into and through heat chamber HC to smoke chamber SC, as indicated in FIG. 2, so to smoke whatever food is placed on the portion of the cooking grate on the smoke chamber side of grill G.

Those skilled in the art will appreciate, that the number of vent holes formed in sections 12 and 14 can be different than the number shown in the drawings without departing from the scope of the invention. Next, the diameter and shape of the holes 20 and 24 can be larger or smaller than as shown in the drawing, again without departing from the scope of the invention. Further, the hole pattern in each section can be different than as shown in FIG. 3A, again without departing from the scope of the invention.

Finally, those skilled in the art will understand that other accessory constructions are possible without departing from the scope of the invention. For example, the accessory could include holes and vents rather than just one or the other. Regardless of the construction, the accessory design is such as to allow heat and smoke to efficiently flow from the heat chamber to the smoke chamber so to smoke the food placed on the portion of the cooking grate on the smoke chamber side of the grill.

When smoking is completed, and cover C is removed from the grill, accessory 10 is easily removed by lifting it off the cooking grate. The accessory can then be cleaned and stored for subsequent use, including being stored on accessory racks by means of one of the hanging holes 18.

Regardless of the construction of the accessory, when installed, it functions as a heat shield blocking direct heat from heating chamber HC onto the food. This allows the smoke and lower temperatures (about 235° F.) to slowly cook the meat throughout, rather than burning the outside of the food before the inside is cooked. The lower vents or holes allow air onto the coals to keep them burning. The upper vents or holes facilitate flow of the smoke and warm air into smoking chamber SC.

Cooler fresh air is drawn into the grill through the lower vent LV fueling the charcoal B that in turn smolders the wood W creating smoke. The heated air and smoke rise in the heat chamber HC passing through holes 20 and over the top half of the accessory 14. As the smoke travels across the smoke chamber SC it cools slightly and drops on the side of the grill kettle opposite the accessory 10. A continuous flow of fresh air being drawn through the lower vent LV to the charcoal B helps create a current that draws the now cooler air across the bottom of the grill tub thusly surrounding the meat M in moving smoke. As the cooler smoke approaches the accessory 10, the heat being dispersed through the entirety of the accessory warms the cooler smoke causing it to rise, joining the smoke that is freshly created by the charcoal B and wood W. This creates smoke convection and keeps the meat from sitting in stagnant smoke, which is important for quality smoking and a more healthful result. As the volume of smoke particles increase within the chamber, smoke is then forced out of the upper vent UV.

In view of the above, it will be seen that the several objects and advantages of the present disclosure have been achieved and other advantageous results have been obtained.

Having thus described the invention, what is claimed and desired to be secured by Letters Patent is:

1. An accessory for a grill used to cook or barbecue food for converting the grill to a smoker comprising a sheet adapted to vertically fit on a cooking grate portion of the grill so to divide the grill, when a cover is placed over it into a heat chamber and a smoke chamber, wood and charcoal being placed in the heat chamber and food to be smoked placed on a portion of the cooking grate within the smoke chamber, the sheet being formed to allow passage of heated air from the heat chamber into the smoke chamber to smoke the food.

2. The accessory of claim 1 in which a slot is formed in the sheet and extends from a bottom of the sheet to a point approximately halfway the height of the sheet, the slot allowing the sheet to be placed on the cooking grate.

3. The accessory of claim 2 in which the sheet further includes means for directing heat and air from the heat chamber into the smoke chamber.

4. The accessory of claim 3 in which said means includes holes formed in the sheet, the holes being of a predetermined size and arranged in a predetermined pattern.

5. The accessory of claim 3 in which said means includes vents formed in the sheet, the vents being of a predetermined size and arranged in a predetermined pattern.

6. The accessory of claim 3 in which said means includes holes formed in one section of the sheet and vents formed in another section thereof, the holes and vents being of predetermined sizes and patterns.

7. The accessory of claim 1 in which the accessory is formed of a single sheet.

8. The accessory of claim 1 in which the accessory is formed of two separate sheets that are connected together.
